(19) United States
(12) Patent Application Publication
(10) Pub. No.: US 2013/0141056 A1
(43) Pub. Date: Jun. 6, 2013

(54) ADAPTIVE FREQUENCY COMPENSATION FOR PFC POWER CONVERTER OPERATING IN CCM AND DCM

(71) Applicants: Ta-Yung YANG, Taoyuan City (TW); Ying-Chi CHEN, Taipei City (TW); Chien-Tsun HSU, Taipei City (TW); Cheng-Sung CHEN, Taichung City (TW)

(72) Inventors: Ta-Yung YANG, Taoyuan City (TW); Ying-Chi CHEN, Taipei City (TW); Chien-Tsun HSU, Taipei City (TW); Cheng-Sung CHEN, Taichung City (TW)

(73) Assignee: SYSTEM GENERAL CORPORATION, New Taipei City (TW)

(21) Appl. No.: 13/560,519

(22) Filed: Jul. 27, 2012

Related U.S. Application Data
(60) Provisional application No. 61/565,543, filed on Dec. 1, 2011.

(51) Int. Cl. G05F 1/70

(52) U.S. Cl. 323/205

(57) ABSTRACT

A control circuit of a power factor correction (PFC) converter is provided. The control circuit includes a pulse width modulation (PWM) circuit, an amplifier, a detection circuit., and a capacitor. The PWM circuit generates a switching signal in response to a loop signal. The amplifier is coupled to generate the loop signal in response to a switching current. The detection circuit generates a mode signal coupled to change output impedance of the amplifier. The capacitor is coupled to the amplifier for loop frequency compensation. The switching signal is coupled to switch an inductor of the PFC power converter and generate the switching current.

### CROSS REFERENCE TO RELATED APPLICATIONS

This application claims the benefit of U.S. Provisional Application No. 61/565,543, filed on Dec. 1, 2011, the contents of which are incorporated herein by reference.

### BACKGROUND OF THE INVENTION

1. Field of the Invention

The invention relates to a control circuit, and more particularly to a control circuit of a PFC (power factor correction) power converter for adaptive frequency compensation of the FPC converter operating in a CCM (continuous current mode) and a DCM (discontinuous current mode).

2. Description of the Related Art

In a conventional PFC (power factor correction) power converter, there is a current loop through an inductor. The loop gain of the current loop is different when the PFC power converter operates in a CCM (continuous current mode) and a DCM (discontinuous current mode). The loop gain is higher in the CCM operation. Thus, a lower bandwidth is required for achieving the loop stability of the current loop. However, the lower bandwidth's current loop results in a poor PF value.

Thus, it is desired to provide a control circuit of a PFC power converter, which provides improved frequency compensation for a current loop of the PFC power converter.

### BRIEF SUMMARY OF THE INVENTION

An exemplary embodiment of a control circuit of a power factor correction (PFC) converter is provided. The control circuit comprises a pulse width modulation (PWM) circuit, an amplifier, a detection circuit, and a capacitor. The PWM circuit generates a switching signal in response to a loop signal. The amplifier is coupled to generate the loop signal in response to a switching current. The detection circuit generates a mode signal coupled to change output impedance of the amplifier. The capacitor is coupled to the amplifier for loop frequency compensation. The switching signal is coupled to switch an inductor of the PFC power converter and generate the switching current.

An exemplary embodiment of a method for controlling a power factor correction (PFC) converter is provided. The method comprises the steps of: generating a switching signal in response to a loop signal; generating the loop signal in accordance with a switching current; generating a mode signal coupled to change impedance associated with the loop signal; compensating for the loop frequency compensation of the PFC power converter with a capacitor. The switching signal is coupled to switch an inductor of the PFC power converter and generate the switching current.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 shows a PFC power converter;

FIG. 1A shows DCM waveforms of a switching signal, a switching current, and a switching current signal in FIG. 1;

FIG. 1B shows CCM waveforms of a switching signal, a switching current, and a switching current signal in FIG. 1;

FIG. 2 shows an exemplary embodiment of a control circuit of the PFC power converter in FIG. 1;

FIG. 3 shows an exemplary embodiment of a synthesis circuit of the control circuit in FIG. 2;

FIG. 4 shows an exemplary embodiment of an emulation circuit 170 of the synthesis circuit in FIG. 3;

FIG. 5 shows an exemplary embodiment of a detection circuit of the control circuit in FIG. 2;

FIG. 6 shows an exemplary embodiment of a PWM circuit of the control circuit in FIG. 2;

FIG. 7 shows waveforms of a ramp signal, a pulse signal, a switching signal, and a pulse of the control circuit in FIG. 2;

FIGS. 8 and 9 show equivalent circuits of a transconductance amplifier of the control circuit in FIG. 2; and

FIG. 10 shows waveforms of a switching-current command signal, a synthesis current signal, an equivalent voltage, and a current loop signal of the control circuit in FIG. 2.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

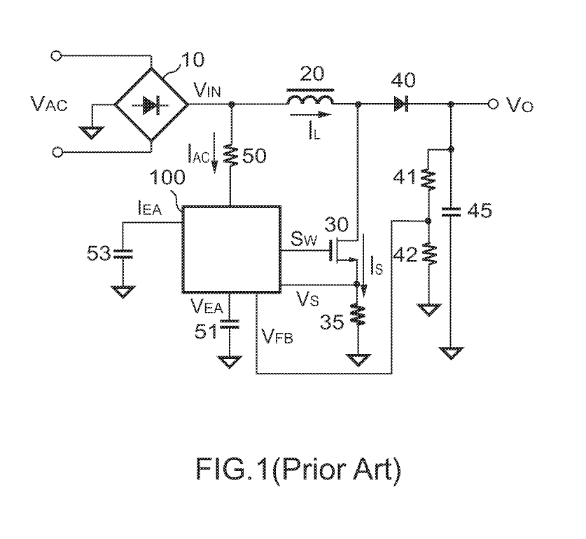

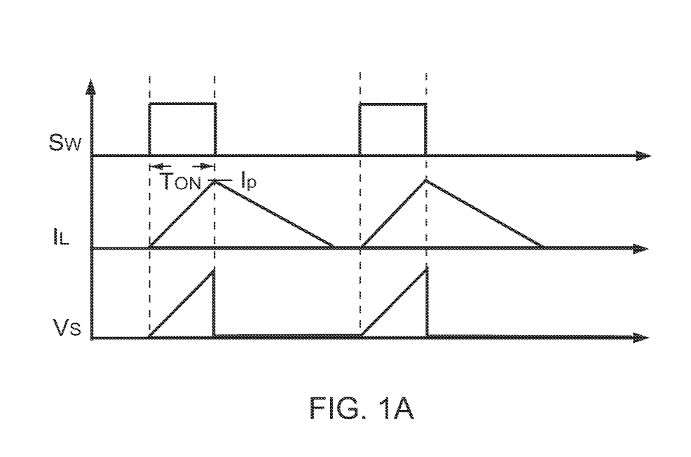

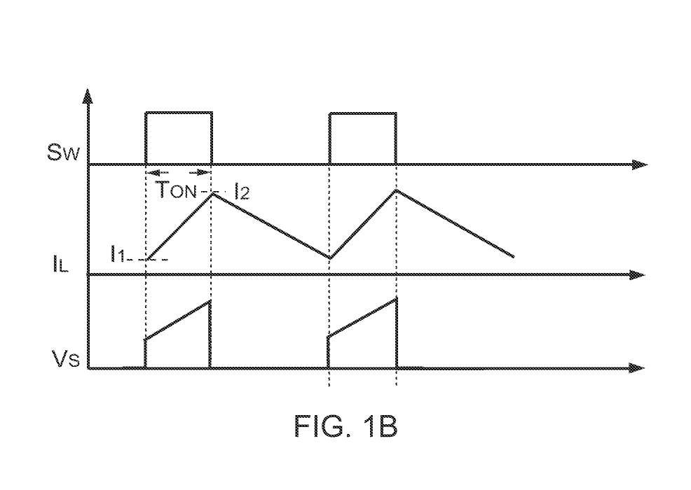

The present invention provides a method and apparatus for frequency compensation of a PFC (power factor correction) power converter operating in a CCM (continuous current mode) and a DCM (discontinuous current mode). FIG. 1 is a PFC power converter. Referring to FIG. 1, the PFC power converter comprises a resistor 35 connected to sample a switching current I_{L} of an inductor 20 and generate a switching current signal V_{S} coupled to a PFC control circuit 100. According to the switching current signal V_{S}, the control circuit 100 will generate a switching signal S_{W} to switch the inductor 20 and generate the switching current I_{L} via a power transistor 30. Through the sensing of the switching current signal V_{S}, the control circuit 100 generates the switching signal S_{W} for producing the switching current I_{L}. The switching current I_{L} further generate the switching current signal V_{S} at the resistor 35, which develops a current loop for PFC control. A capacitor 53 is used for the frequency compensation of the current loop. As described above, the loop gain of the current loop is different when the PFC power converter operates in the CCM or DCM. The loop gain is higher in the CCM operation. Thus, a lower bandwidth (higher capacitance of the capacitor 53) is required for achieving the loop stability of the current loop. However, the lower bandwidth's current loop results in a poor PF value. The object of this invention is to develop adaptive frequency compensation for the current loop to achieve a stable CCM operation and a good PF value for both CCM and DCM.

A resistor 50 is coupled to detect an input voltage V_{IN} coupled to the inductor 20 and generate an input-voltage signal I_{AC} coupled to the control circuit 100. The input voltage V_{IN} is generated by a rectifier 10 according to an AC voltage V_{AC}. The switching current I_{L} of the inductor 20 is discharged to an output capacitor 45 via a rectifier 40 to generate an output voltage V_{O}. Resistors 41 and 42 form a voltage divider coupled to the output of the PFC power converter to detect the output voltage V_{O} and generate a signal V_{FB} coupled to the control circuit 100 for the regulation of the output voltage V_{O}. The signal V_{FB}, the switching signal S_{W}, and the output voltage V_{O} develop a voltage loop for the PFC control. A capacitor 51 is used for the frequency compensation of the voltage loop.

FIG. 1A shows the DCM waveforms of the switching signal S_{W}, the switching current I_{L}, and the switching current signal V_{S}. The switching current I_{L} of the inductor 20 is fully discharged before the start of the next switching cycle.

FIG. 1B shows the CCM waveforms of the switching signal S_{W}, the switching current I_{L}, and the switching current signal V_{S}. The switching current I_{L} of the inductor 20 still has a current I₁ existed in the inductor 20 before the start of the next switching cycle. Therefore, the gain of the CCM is high.

$$\begin{matrix}L \times \frac{d i}{d t} = L \times \frac{{I}_{A} + {I}_{B}}{T} = L \times \frac{1}{T} \times ( {I}_{1} \times {T}_{ON} + \frac{{V}_{IN}}{L} \times {T}_{ON} ) & ( 1 ) \\ {I}_{L} = \frac{1}{T} \times ( {I}_{1} \times {T}_{ON} + \frac{{V}_{IN}}{L} \times {T}_{ON} ) & ( 2 ) \\ \frac{\partial {I}_{L}}{\partial {T}_{ON}} = \frac{{I}_{1}}{T} + \frac{{V}_{IN}}{T \times L} & ( 3 ) \\ {V}_{O} = {V}_{IN} + ( L \times \frac{d i}{d t} ) & ( 4 ) \\ {V}_{O} = {V}_{IN} + [ L \times \frac{1}{T} \times ( {I}_{1} \times {T}_{ON} + \frac{{V}_{IN}}{L} \times {T}_{ON} ) ] & ( 5 ) \\ \frac{\partial {V}_{O}}{\partial {T}_{ON}} = \frac{{I}_{1} \times L}{T} + \frac{{V}_{IN}}{T} & ( 6 )\end{matrix}$$

wherein L is the inductance of the inductor 20; T is the switching period; T_{ON} is on time of the switching signal S_{W}.

Equation (3) is the current loop gain (the switching current I_{L} versus “the on time T_{ON} of the switching signal S_{W}”). The continuous current I₁ causes the higher current loop gain. Equation (6) is the voltage loop gain (the output voltage VO versus “the on time T_{ON} of the switching signal S_{W}”). The continuous current I₁ causes the higher voltage loop gain as well.

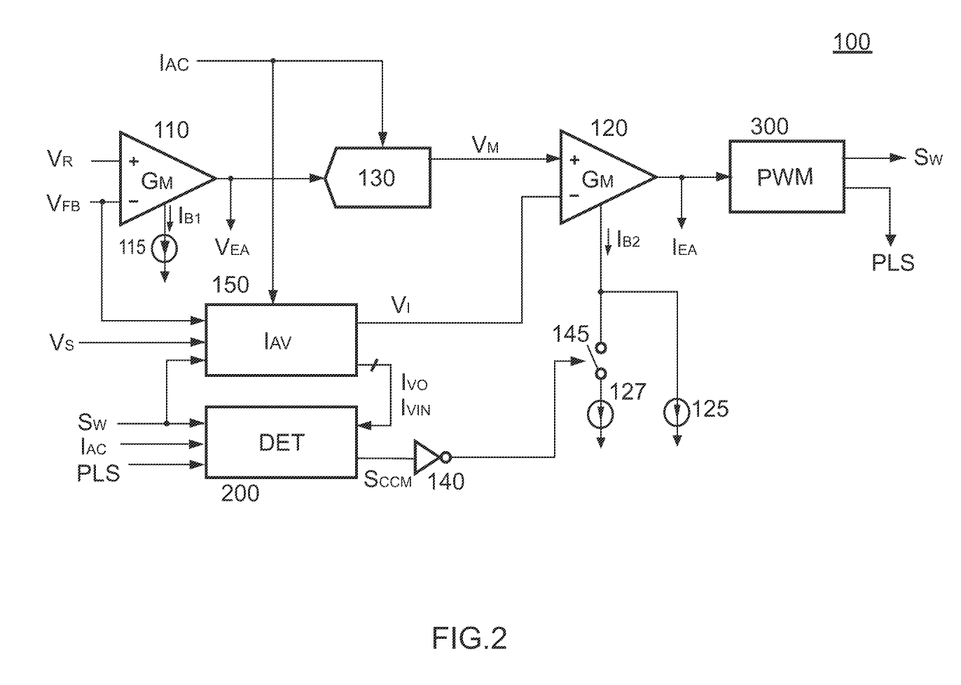

FIG. 2 is a preferred embodiment of the control circuit 100 according to the present invention. A transconductance amplifier (Gm) 110 is coupled to receive the signal V_{FB} and a reference signal V_{R} for generating a voltage loop signal V_{EA}. The capacitor 51 is coupled to the voltage loop signal V_{EA} (shown in FIG. 1) for the voltage loop compensation. A current source 115 provides a bias current Iₘ for the transconductance amplifier 110. A multiplier-divider (M) 130 generates “a switching-current command signal V_{M}” in accordance with the voltage loop signal V_{EA} and the input-voltage signal I_{AC}. The skill of the multiplier-divider 130 can be found in the prior art of “Multiplier-divider circuit for a PFC controller”, U.S. Pat. No. 7,057,440.

A synthesis circuit (I_{AV}) 150 is couple to receive the switching current signal V_{S} for generating a synthesis current signal V₁. The switching current signal V_{S} is only available during the on time T_{ON} of the switching signal S_{W}. Because the transistor 30 is turned off, the switching current signal V_{S} is at a zero value during the off time of the switching signal S_{W}, which is shown in FIG. 1A and FIG. 1B. The synthesis circuit 150 is utilized to emulate the switching current I_{L} during the discharge period of the inductor 20 (the turned-off period of the switching signal S_{W}). Thus, the synthesis current signal V_{I} includes the switching current signal V_{S} and its discharge signal in the discharge period. The signal V_{FB}, the input-voltage signal I_{AC}, and the switching signal S_{W} are coupled to the synthesis circuit 150 for emulating the discharge signal. The synthesis circuit 150 further generates signals I_{VO} and I_{VIN} coupled to a detection circuit (DET) 200. The signal I_{VO} is correlated to the level of the output voltage V_{O}. The signal I_{VIN} is correlated to the level of the input voltage V_{IN}. The detection circuit 200 is coupled to receive the switching signal S_{W}, the input-voltage signal I_{AC}, and a pulse signal PLS for generating a CCM signal S_{CCM} (mode signal). The CCM signal S_{CCM} is used to indicate the CCM or DCM operation. For example, in the embodiment, the CCM signal S_{CCM} is generated (enabled) when the switching current I_{L} is operated in the CCM.

A transconductance amplifier (Gm) 120 receives the switching-current command signal V_{M} and the synthesis current signal V_{I} for generating a current loop signal I_{EA}. The capacitor 53 is coupled to the current loop signal I_{EA} for the current loop compensation. Current sources 125 and 127 form a bias current I_{B2} for the transconductance amplifier 120. The current source 127 is turned off during the DCM operation and turned on during the CCM operation. A switch 145 and the current source 127 are coupled between the transconductance amplifier 120 and the ground in series. The switch 145 is controlled to be turned on or off by the CCM signal S_{CCM} through an inverter 140. Accordingly, the on/off state of the current source 127 is controlled by the CCM signal S_{CCM} via the inverter 140 and the switch 145. The bias current I_{B2} will provide a maximum output current for the transconductance amplifier 120. The maximum output current of the transconductance amplifier 120 associated with the capacitor 53 determines the current loop signal I_{EA}. A pulse width modulation (PWM) circuit (PWM) 300 generates the switching signal S_{W} in accordance with the current loop signal I_{LA}. The PWM circuit 300 further generates the signal PLS coupled to the detection circuit 200.

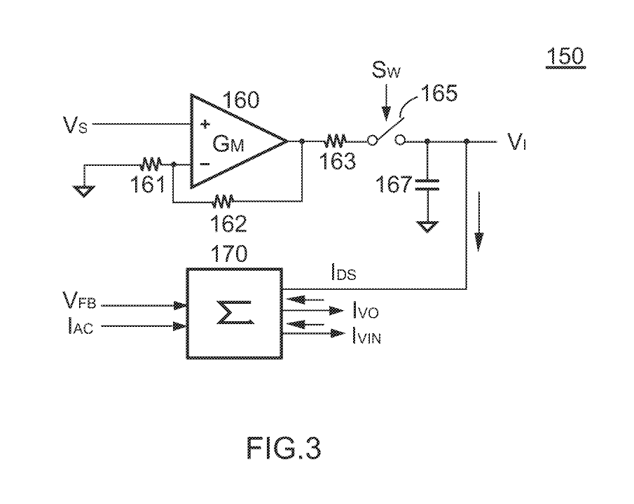

FIG. 3 is a preferred embodiment of the synthesis circuit 150 according to the present invention. An amplifier 160 cooperating with resistors 161-163 is coupled to sample the switching current signal V_{S} via a switch 165 during the on time of the switching signal S_{W}. The switching current signal V_{S} is hold in a capacitor 167 after the switch 165 is turned off. An emulation circuit 170 generates a discharge current I_{DS} in response to the signals V_{FB} and the input-voltage signal I_{AC}. The discharge current I_{DS} is coupled to discharge the capacitor 167 for emulating the discharge signal of the synthesis current signal V_{I} during the discharge period of the inductor 20. The emulation circuit 170 further generates the signals I_{VO} and I_{VIN} coupled to the detection circuit 200.

The emulation circuit 170 is developed for generating the discharge current I_{DS}. The detailed operation for the discharge (demagnetizing) of the inductor can be found in a prior art “Method and apparatus for detecting demagnetizing time of magnetic device”, U.S. Pat. No. 7,471,523.

$${T}_{DS} = {T}_{ON} \times k \times \frac{{V}_{IN}}{( {V}_{O} - {V}_{IN} )} \qquad ( 7 )$$

wherein k is a constant.

The discharge current I_{DS} is correlated to the discharge time T_{DS}. The input-voltage signal I_{AC} is correlated to the input voltage V_{IN}. The signal V_{FB} is correlated to the output voltage V_{O}. The discharge current I_{DS} associated with the capacitance of the capacitor 167 determines the discharge time T_{DS}.

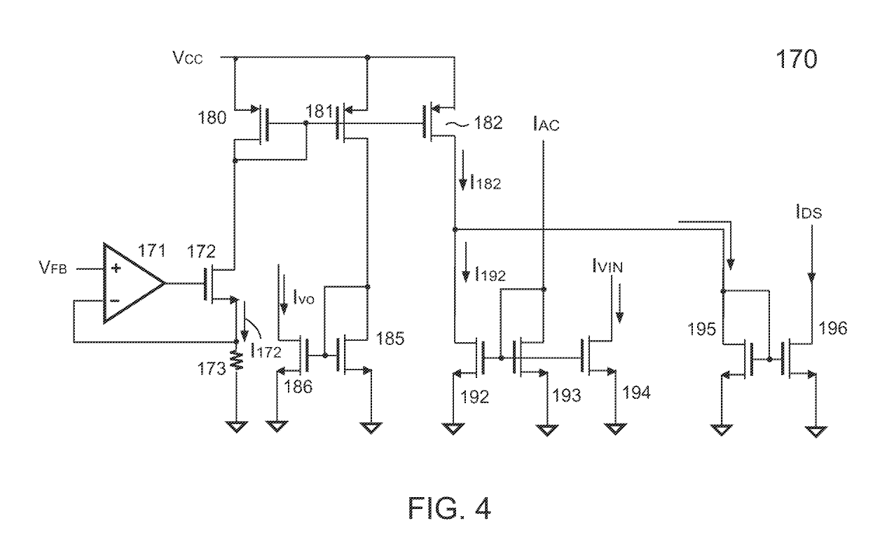

FIG. 4 is a preferred embodiment of the emulation circuit 170 according to the present invention. An amplifier 171, a resistor 173, and a transistor 172 develop a V-to-I converter for generating a current I₁₇₂ in accordance with the signal V_{FB}. Transistors 180, 181, 182, 185, and 186 form a first current mirror to generate the signal I_{VO} and a current I₁₈₂. Transistors 192, 193, and 194 form a second current mirror to generate the signal I_{VIN} and a current I₁₉₂. Transistors 195 and 196 develop a third current mirror to generate the discharge current I_{DS} in response to the current I₁₈₂ and the current I₁₉₂.

$${V}_{FB} = {V}_{O} \times \frac{{R}_{42}}{{R}_{41} + {R}_{42}} \\ {I}_{182} = \{ [ {V}_{O} \times \frac{{R}_{42}}{{R}_{41} + {R}_{42}} ] \div {R}_{173} \} \times k 1 \\ {I}_{192} = {I}_{AC} \times k 2 \\ {I}_{DS} = {I}_{182} - {I}_{192} \\ {I}_{AC} = \frac{{V}_{IN}}{{R}_{50}} ( shown in FIG . 1 ) \qquad ( 8 )$$

wherein R₄₁, R₄₂, and R₁₇₃ are the resistance of the resistors 41, 42, and 173 respectively.

The discharge current I_{DS} shown in Equation (8) can be expressed as Equation (9)

$${I}_{DS} = \{ [ {V}_{O} \times \frac{{R}_{42}}{{R}_{41} + {R}_{42}} ] \div {R}_{173} \} \times k 1 - ( \frac{{V}_{IN}}{{R}_{50}} \times k 2 ) \qquad ( 9 )$$

wherein k1 and k2 are current mirror ratios.

The charge slope of the switching current signal V_{S} is equal to the discharge slope of the synthesis current signal V_{I}, which is shown in Equation (10)

$$( \frac{{V}_{IN}}{L} \times {T}_{ON} ) \times {R}_{35} \times k 3 = \frac{{I}_{DS}}{{C}_{167}} \times {T}_{DS} \qquad ( 10 )$$

wherein R₃₅ is the resistance of the resistor 35.

It can be rewritten as Equations (11) and (12),

$$\begin{matrix}( \frac{{V}_{IN}}{L} \times {R}_{35} \times k 3 ) \times {T}_{ON} = \frac{1}{{C}_{167}} \times \{ [ {V}_{O} \times \frac{{R}_{42}}{{R}_{173} \times ( {R}_{41} + {R}_{42} )} ] \times k 1 - ( \frac{{V}_{IN}}{{R}_{50}} \times k 2 ) \} \times {T}_{DS} & ( 11 ) \\ {V}_{IN} \times {k}_{A} \times {T}_{ON} = ( {V}_{O} \times {k}_{B} - {V}_{IN} \times {k}_{C} ) \times {T}_{DS} & ( 12 )\end{matrix}$$

wherein R₅₀ is the resistance of the resistor 50; C₁₆₇ is the capacitance of the capacitor 167, and

$${k}_{A} = ( \frac{1}{L} \times {R}_{35} \times k 3 )$$

$${k}_{B} = \frac{1}{{C}_{167}} \times \frac{{R}_{42}}{{R}_{173} \times ( {R}_{41} + {R}_{42} )} \times k 1$$

$${k}_{C} = \frac{1}{{R}_{50}} \times k 2$$

$$set {k}_{B} = {k}_{C} ;$$

$$and$$

$$k = \frac{{k}_{A}}{{k}_{B}}$$

Equation (12) can be rewritten as Equation (7).

$${T}_{DS} = {T}_{ON} \times k \times \frac{{V}_{IN}}{( {V}_{O} - {V}_{IN} )}$$

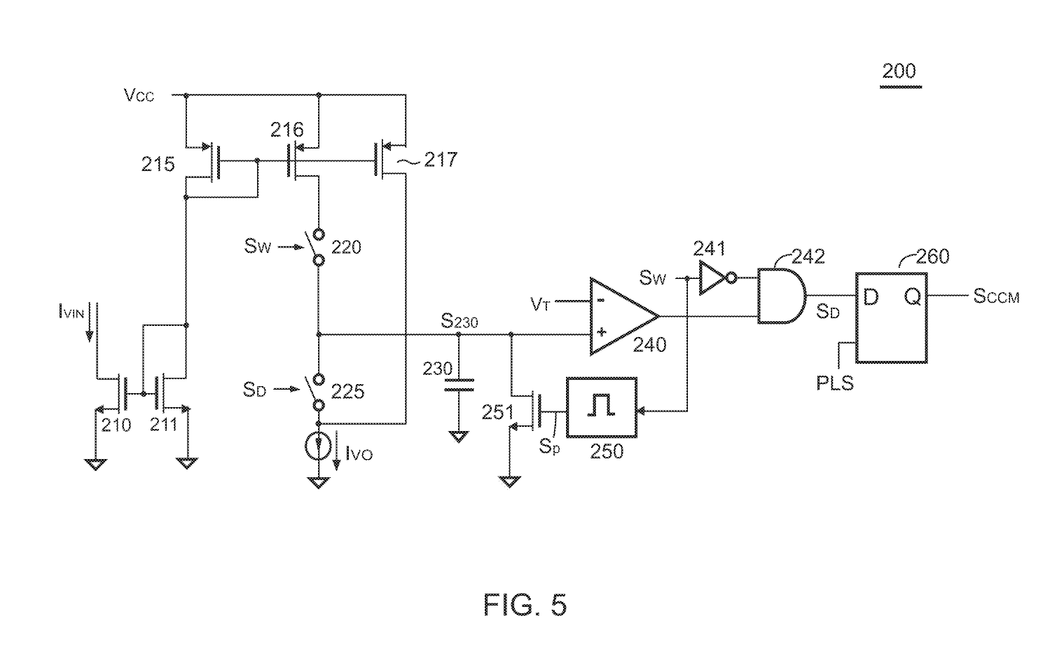

FIG. 5 is a preferred embodiment of the detection circuit 200 according to the present invention. The signal I_{VIN} is coupled to charge a capacitor 230 via transistors 210, 211, 215, and 216 and a switch 220 during on time of the switching signal S_{W}. When the switching signal S_{W} is turned off, the signal I_{VO} and the signal I_{VIN} are coupled to discharge the capacitor 230 via a switch 225 and a transistor 217 during the discharge time T_{DS}. A discharge signal S_{D} controls the switch 225. The enable of the discharge signal S_{D} indicates the discharge time T_{DS}. The switching signal S_{W} controls the switch 220. According to the rising edge of the switching signal S_{W}, a pulse generator 250 generates a pulse signal Sp coupled to discharge the capacitor 230 through a transistor 251. A saw signal S₂₃₀ is thus generated in the capacitor 230 in response to the switching signal S_{W}.

A comparator 240 is utilized to compare the saw signal S₂₃₀ with a threshold V_{T}. The output of the comparator 240 is coupled to enable the discharge signal S_{D} via an AND gate 242 and an inverter 241 when the switching signal S_{W} is turned off and the saw signal S₂₃₀ is higher than the threshold V_{T}. The discharge signal S_{D} and the pulse signal PLS are coupled to a flip-flop 260 for generating the CCM signal S_{CCM}. The rising edge of the pulse signal PLS is applied to enable the switching signal S_{W} and latch the status of the discharge signal S_{D} (in the flip-flop 260). If the switching signal S_{W} is enable (starting a switching cycle) before the end of the discharge time T_{DS} (the discharge signal S_{D}), then the switching operation is a CCM. Equation (13) shows the operation of the detection circuit 200.

(I_{VIN}×ka)×T_{ON}=(I_{VO}−I_{VIN}×kb)×TDS (13)

Equation (13) can be expressed as Equation (14)

(V_{IN}×kc)×T_{ON}=(Vo×kd−V_{IN}×ke)×T_{DS} (14)

set the kd=ke and

$$k = \frac{kc}{kd} ,$$

then Equation (14) will be same as Equation (7). Where ka, kb, kc, kd, and ke are the constant determined by the circuit parameters.

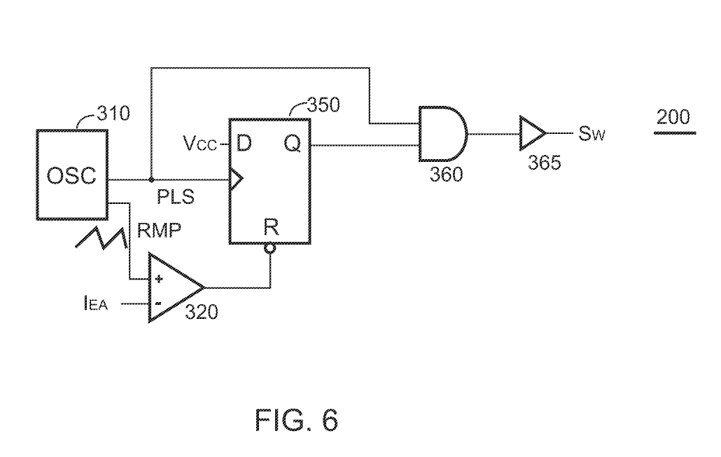

FIG. 6 shows a reference circuit for the PWM circuit 300. An oscillator (OSC) 310 generates the pulse signal PLS and a ramp signal RMP. The pulse signal PLS is coupled to generate the switching signal S_{W} and provide a dead-time for the switching signal S_{W}. The ramp signal RMP is coupled to compare with the current loop signal I_{EA} for the reset of a flip-flop 350 via a comparator 320. Through an AND gate 360 and an output buffer 365, the flip-flop 350 generates the switching signal S_{W}.

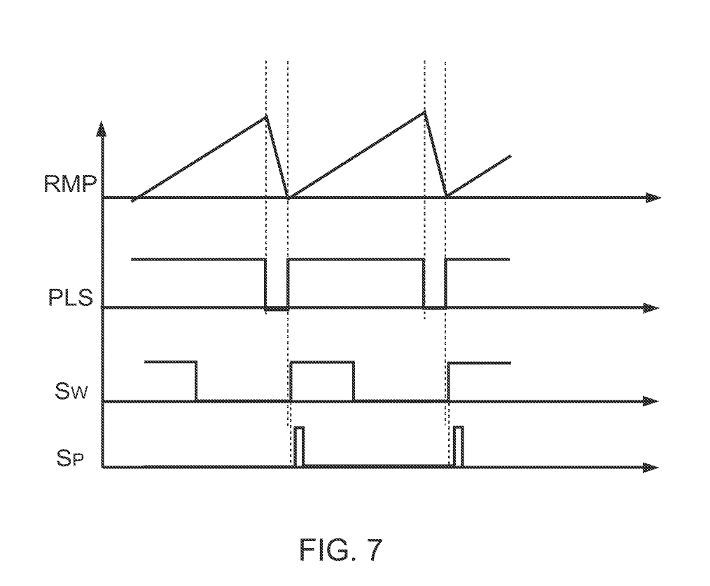

FIG. 7 shows the waveforms of the ramp signal RMP, the pulse signal PLS, the switching signal S_{W}, and the pulse signal S_{P}.

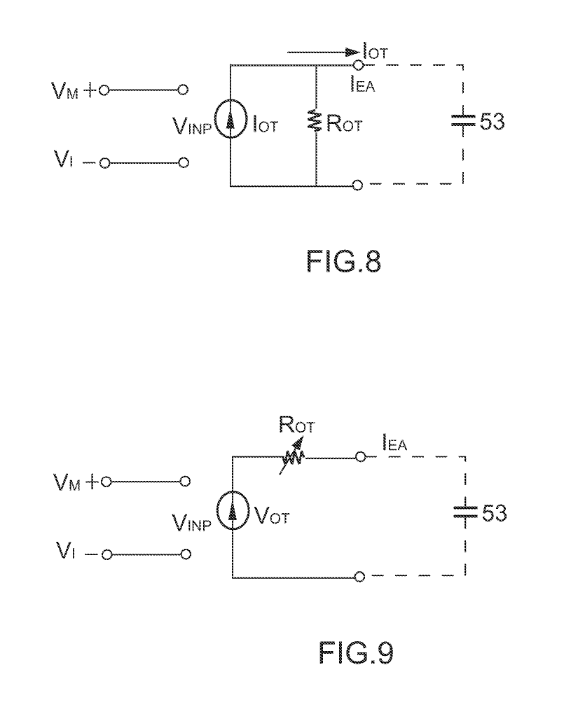

FIG. 8 is an equivalent circuit of the transconductance amplifier 120. The capacitor 53 is connected to the output of the transconductance amplifier 120. A equivalent output resistance R_{OT} and the capacitance of the capacitor 53 develop a low-pass filter for the current loop signal I_{EA}. The gain Gm of the transconductance amplifier 120 can be expressed,

$${G}_{m} = \frac{{I}_{OT}}{{V}_{INP}}$$

wherein I_{OT} is an equivalent current; V_{INP} is differential input voltage of the transconductance amplifier 120.

FIG. 9 is an equivalent circuit for the circuit shown in FIG. 8.

V_{OT}=I_{OT}×R_{OT}=Gₘ×V_{INP}×R_{OT}

However, the maximum output voltage of the transconductance amplifier 120 is limited by its supply voltage V_{CC}, in which the equivalent voltage V_{OT} will be saturated and clamped by the supply voltage V_{CC} in response to a higher value of the differential input voltage V_{INP}. The equivalent output resistance R_{OT} can be expressed as,

$${R}_{OT} = \frac{{V}_{OT}}{{I}_{OT}} \approx \frac{{V}_{OT ( max )}}{m \times {I}_{B 2}} \approx \frac{{V}_{CC}}{m \times {I}_{B 2}} \qquad ( 15 )$$

where m is a constant.

In accordance with Equation (15), we can find that the equivalent output resistance (also referring to as output impedance) R_{OT} can be changed by the change of the bias current I_{B2}. The equivalent output resistance R_{OT} associated with the capacitor 53 develops a pole F_{P} for the loop compensation. The pole F_{P} will reduce the current loop gain. A lower bias current I_{B2} produces a higher equivalent output resistance R_{OT} and a lower frequency pole F_{P}.

$${F}_{P} = \frac{I}{2 π \times {R}_{OT} \times {C}_{53}}$$

According to the present invention, a lower bias current I_{B2} is utilized to reduce the bandwidth and the current loop gain for stabilizing the CCM operation. A higher bias current I_{B2} is applied to increase the bandwidth for achieving a better PF value for the PFC power converter.

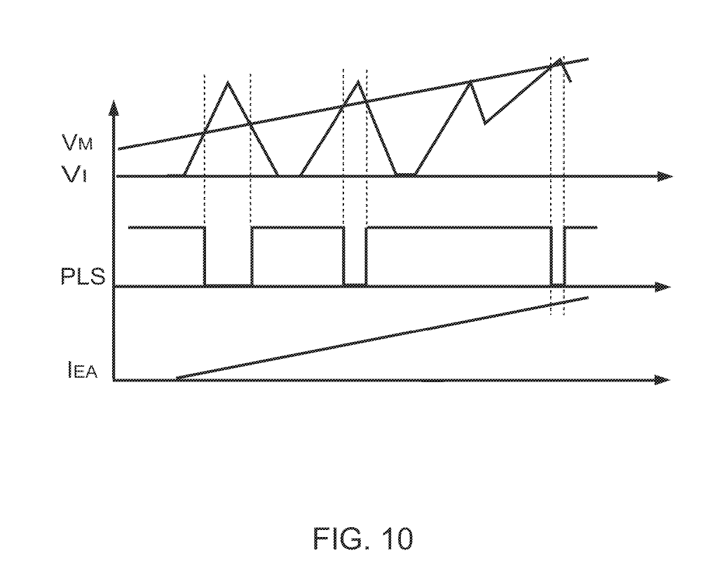

FIG. 10 shows the waveforms of the switching-current command signal V_{M}, the synthesis current signal V_{I}, the equivalent voltage V_{OT}, and the current loop signal I_{EA}.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A control circuit of a power factor correction (PFC) converter comprising:
a pulse width modulation (PWM) circuit generating a switching signal in response to a loop signal;
an amplifier coupled to receive a switching current for generating the loop signal;
a detection circuit generating a mode signal coupled to change output impedance of the amplifier; and
a capacitor coupled to the amplifier for loop frequency compensation;
wherein the switching signal is coupled to switch an inductor of the PFC power converter and generate the switching current.

2. The circuit as claimed in claim 1, wherein the mode signal indicates a CCM (continuous current mode) or DCM (discontinuous current mode) operation.

3. The circuit as claimed in claim 1, wherein the mode signal is generated in response to an input voltage of the PFC power converter, an output voltage of the PFC power converter, and the switching signal.

4. The circuit as claimed in claim 1, wherein the amplifier is a transconductance amplifier.

5. The circuit as claimed in claim 1, wherein the mode signal is coupled to change a bias current of the amplifier.

6. The circuit as claimed in claim 1, wherein the loop signal is a current loop signal generated by comparing the switching current with a command signal.

7. The circuit as claimed in claim 6, wherein the command signal is generated

8. A method for controlling a power factor correction (PFC) converter comprising:
generating a switching signal in response to a loop signal;
generating the loop signal in accordance with a switching current;
generating a mode signal coupled to change the impedance of the loop signal;
compensating the loop signal with a capacitor;
wherein the switching signal is coupled to switch an inductor of the PFC power converter and generate the switching current.

9. The method as claimed in claim 8, wherein the mode signal indicates a CCM (continuous current mode) or DCM (discontinuous current mode) operation.

10. The method as claimed in claim 8, wherein the mode signal is generated in response to an input voltage of the PFC power converter, an output voltage of the PFC power converter, and the switching signal.

11. The method as claimed in claim 8, wherein the loop signal is generated by a transconductance amplifier.

12. The method as claimed in claim 8, wherein the mode signal is coupled to change a bias current of the transconductance amplifier.

13. The method as claimed in claim 8, wherein the loop signal is a current loop signal generated by comparing the switching current with a command signal.

14. The method as claimed in claim 13, wherein the command signal is generated in response to an input voltage of the PFC power converter.

15. The method as claimed in claim 8, wherein the impedance associated with the loop signal and capacitance of the capacitor develop a low-pass filter for the loop signal.
